(19) United States
(12) Patent Application Publication
(10) Pub. No.: US 2015/0184628 A1
(43) Pub. Date: Jul. 2, 2015

(54) FOBLESS KEYLESS VEHICLE ENTRY AND INGNITION METHODAND SYSTEM

(71) Applicant: Zhigang Fan, Webster, NY (US)

(72) Inventor: Zhigang Fan, Webster, NY (US)

(21) Appl. No.: 14/579,991

(22) Filed: Dec. 22, 2014

Related U.S. Application Data
(60) Provisional application No. 61/920,802, filed on Dec. 26, 2013.

(51) Int. Cl. F02N 11/08; G07C 9/00

(52) U.S. Cl. CPC F02N 11/0807; G07C 9/00182; G07C 2009/00301

(57) ABSTRACT

A fobless keyless vehicle entry and ignition control system and method. The system contains a vehicle sub-system and a mobile device sub-system. A wireless communication connection is established between the two sub-systems and authorization information is exchanged. Once the authorization is verified, position of the mobile device relative to the vehicle is determined by measuring the time delays of sending and receiving acoustic signals between the two sub-systems. The controls to door entry and engine ignition are granted when the authorization is verified and the position is within the predefined ranges.

### CROSS-REFERENCE TO RELATED APPLICATION

This application hereby claims priority under 35 U.S.C. .sctn.119 to U.S. Provisional Patent Application No. 61/920,802 filed Dec. 26, 2013, entitled “ FOBLESS KEYLESS VEHICLE ENTRY AND IGNITION METHOD AND SYSTEM,” the disclosure of which is incorporated herein by reference.

### TECHNICAL FIELD

Embodiments are generally related keyless vehicle entry and ignition methods and systems. Embodiments are further related to a mobile phone based keyless vehicle entry and ignition method and system.

### BACKGROUND OF THE INVENTION

Keyless entry and ignition systems have been widely used in modern vehicles. Instead of using a car key, the driver may carry a key fob. The key fob allows users unlocking or locking the doors and starting the engine without searching keys in their pocket or purse, and thus provide significant convenience.

The keyless entry and ignition systems rely on a series of specially designed radio channels that communicate between the key fob and the vehicle. The radio communication provides two functions: user identification and position determination. The former prevents unauthorized entry. The latter determines the key fob position relative to the vehicle. Unlocking/locking is only permitted when the key fob is in the immediate distance to the vehicle and the ignition can only be started when the user is inside the vehicle.

One inconvenience associated with the traditional keyless entry and ignition systems is the requirement of users to carry a key fob. In addition, the key fob, and the specially designed radio communication devices contained in the vehicle also add hardware cost.

What are therefore needed are convenient and cost effective keyless vehicle entry and ignition systems and methods that do not require special key fobs.

### INCORPORATION BY REFERENCE

U.S. Pat. No. 4,672,375, issued Jun. 9, 1987, by Mochida et al., entitled “Keyless entry system for automotive devices with compact, portable wireless code transmitter, and feature for preventing users from locking transmitter in vehicle”;

U.S. Pat. No. 4,973,958, issued Nov. 27, 1990, by Hirano et al., entitled “Keyless entry system for automotive devices antenna device allowing low power radio signal communication”;

U.S. Pat. No. 5,293,160, issued Mar. 8, 1994, by Kurozu et al., entitled “Keyless vehicle lock system with distance measuring”;

U.S. Pat. No. 5,319,364, issued Jun. 7, 1994, by Waraksa et al., entitled “Passive keyless entry system”;

U.S. Pat. No. 6,236,333, issued May 22, 2001, by King, entitled “Passive remote keyless entry system”;

U.S. Pat. No. 8,284,020, issued Oct. 9, 2012, by Ghabra et al., entitled “Passive entry system and method for a vehicle”.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, an aspect of the disclosed embodiments to provide for a fobless keyless vehicle entry and ignition control system comprising:

a vehicle;

a wireless communication unit residing in said vehicle;

a plurality of acoustic input/output units residing in said vehicle;

a plurality of sensors residing in said vehicle;

a plurality of switches residing in said vehicle;

a remote access device;

a wireless communication unit residing in said remote access device;

an acoustic input/output unit residing in said remote access device;

said wireless communication unit residing in said vehicle communicating with said wireless communication unit residing in said remote access device to verify an authorization;

once said authorization verified, a first party of said acoustic input/output units residing in said vehicle and said acoustic input/output unit residing in said remote access device transmitting an acoustic signal and said signal received by a second party of said acoustic input/output units residing in said vehicle and said acoustic input/output unit residing in said remote access device;

determining distances between said acoustic input/output units residing in said vehicle and said acoustic input/output unit residing in said remote access device by measuring the time delay between transmitting and receiving said acoustic signal;

turning on/off said switches when said distances meet a predetermined condition.

It is, another aspect of the disclosed embodiments to provide for a fobless keyless vehicle entry and ignition control method comprising:

communicating by a wireless communication unit residing in a vehicle with a wireless communication unit residing in a remote access device to verify an authorization;

once said authorization verified, a first party of a plurality of acoustic input/output units residing in said vehicle and an acoustic input/output unit residing in said remote access device transmitting an acoustic signal and said signal received by a second party of said acoustic input/output units residing in said vehicle and said acoustic input/output unit residing in said remote access device;

determining distances between said acoustic input/output units residing in said vehicle and said acoustic input/output unit residing in said remote access device by measuring the time delay between transmitting and receiving said acoustic signal;

turning on/off a switch in said vehicle when said distances meet a predetermined condition.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram depicting a vehicle sub-system in accordance with an embodiment of a present teachings;

FIG. 2 illustrates a block diagram depicting a mobile phone sub-system in accordance with an embodiment of a present teachings;

FIG. 3 illustrates a flow chart depicting a method in accordance with an embodiment of a present teachings.

FIG. 4 illustrates a flow chart depicting a method for acoustic distance measurement in accordance with an embodiment of a present teachings.

### DETAILED DESCRIPTION

This disclosure pertains to a mobile phone based fobless keyless vehicle entry and ignition method and system. With the rapid growth in popularity, mobile phone becomes a necessity in today's daily life, and is almost always being carried by most of the car drivers. Exploiting the short distance communication capability and acoustic transmission/receiving capability existing in mobile phone, the mobile phone is used as the vehicle entry and ignition controller. It eliminates the need of a special key fob. It not only provides user convenience, but also saves hardware costs. While this disclosure discusses a new technique for vehicle entry and ignition, one of ordinary skill in the art would recognize that the techniques disclosed may also be applied to other contexts and applications as well. The techniques disclosed herein are applicable to any number of electronic devices with digital communication systems and acoustic input and output systems, mobile phones, personal data assistants (PDAs), portable music players, digital video cameras, and computers. A computer or an embedded processor that provides a versatile and robust programmable control device that may be utilized for carrying out the disclosed techniques.

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The system of present invention contains two sub-systems, one residing in a vehicle and one residing in a mobile phone, or other portable devices.

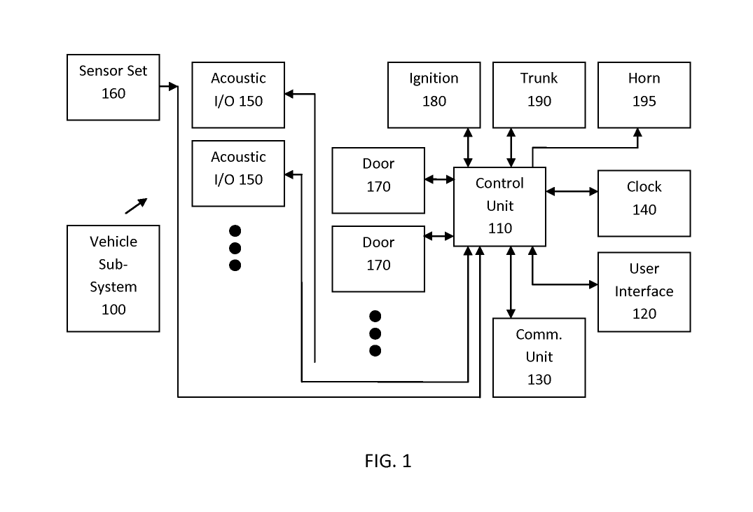

Referring now to FIG. 1, a block diagram of a vehicle sub-system used to illustrate an example embodiment in which several aspects of the present invention may be implemented. The vehicle sub-system 100 is shown containing control unit 110, (optional) user interface 120, communication unit 130, clock 140, acoustic I/O units 150, sensor set 160, door units 170, ignition control unit 180, and trunk unit 190. It may further contain other units that are controlled by the system, such as horn 195. Only the components as pertinent to an understanding of the operation of the example embodiment are included and described, for conciseness and ease of understanding. Each component of FIG. 1 is described in detail below.

Control unit 110 may contain one or more processors, or other logic circuits, with memory or other storage devices.

User interface 120 may contain a screen and a sound output devices showing various user instructions as well as status information and warn signals. It may also contains various buttons and other input mechanisms that receives instructions from the user.

Communication unit 130 transmits information to a mobile phone sub-system 200, according to control unit's instructions. It also receives information from mobile phone sub-system 200 and passes it to control unit 110. An example of communication unit to be applied here is a Bluetooth device. The Bluetooth is a short range radio communication system. They may send/receive signal to/from another Bluetooth device in a range of one meter to one hundred meters. Another example of communication unit is Wi-Fi Direct, which is a Wi-Fi standard that enables devices to connect easily with each other without requiring a wireless access point.

Clock 140 provides control unit 110 with the current time information. It can be set by control unit 110.

One or more acoustic I/O units 150 transmit and/or receive acoustic signals to and/or from mobile phone sub-system 200. In one aspect of the present invention, acoustic I/O units 150 perform both functions of transmission and receiving. In another aspect of the present invention, acoustic I/O units 150 perform only one of the functions of transmission and receiving. The acoustic I/O units are mounted on various parts of the vehicle. In one embodiment of the present invention, three acoustic I/O units are applied. They are mounted on the left door and right door of the vehicle, and near the trunk, respectively.

Sensor set 160 contains different sensors detecting various user actions. It may include a sensor for detecting if the ignition button is being pushed. It may include a sensor for detecting if the break of the vehicle is being pressed. It may also include a sensor in a door handle for detecting if the door handle is being gripped (for indicating user's intention of unlocking the door). It may also include a sensor in a door handle for detecting if a locking-door button on the door handle is being pushed (for indicating user's intention of locking the door). It may further include a sensor detecting if a unlocking trunk button is being pushed (for indicating user's intention of unlocking the trunk).

Control unit 110 may send signals to various control units to perform various tasks. For example, it may instruct door units 170 to lock or unlock vehicle doors. It may send signal to ignition unit 180 to start or stop the engine. It may unlock the trunk through trunk control unit 190, and it may sound the horn through horn control unit 195.

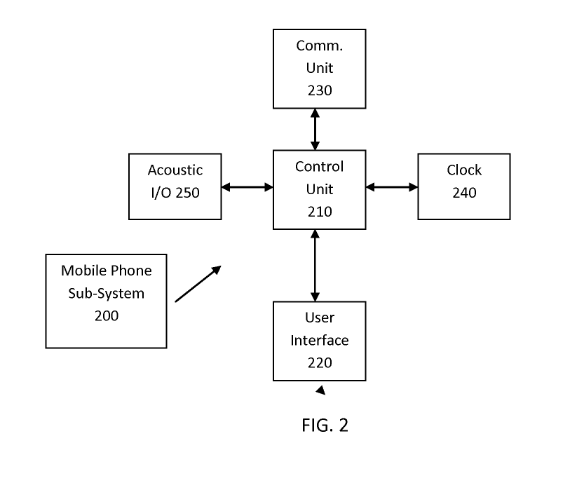

Referring now to FIG. 2, a block diagram of a mobile phone sub-system used to illustrate an example embodiment in which several aspects of the present invention may be implemented. The mobile device sub-system 200 is shown containing control unit 210, user interface 220, communication unit 230, clock 240, and acoustic I/O units 250.

Control unit 210 may contain one or more processors, or other logic circuits, with memory or other storage devices.

User interface 220 may contain a screen and a sound output devices showing various user instructions as well as status information and warn signals. It may also contains various buttons and other input mechanisms that receives instructions from the user.

Communication unit 230 transmits information to the vehicle sub-system 100, according to control unit's instruction. It also receives information from vehicle sub-system 100 and passes it to control unit 210.

Clock 240 provides control unit 210 with the current time information. It and can be set by control unit 210.

Acoustic I/O units 250 transmit and/or receive acoustic signal to and /or from the acoustic I/O units 150 in mobile phone sub-system 100. In one aspect of the present invention, acoustic I/O units 250 perform both functions of transmission and receiving. In another aspect of the present invention, acoustic I/O units 250 perform only one of the functions of transmission and receiving. An example of unit 250 is the speaker (for output) and the microphone (for input) residing in the mobile phone.

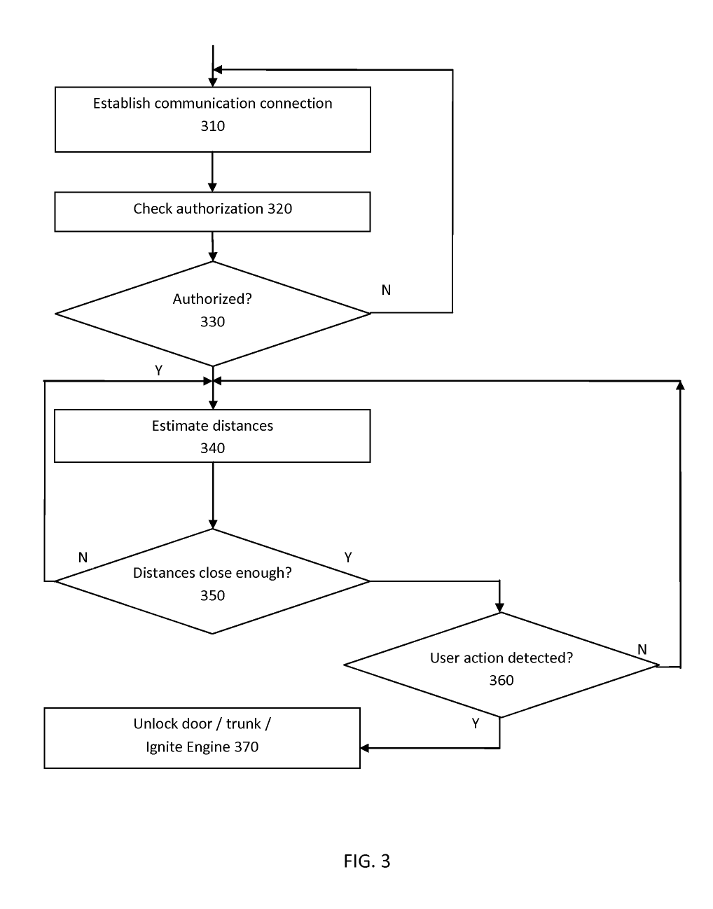

Referring now to FIG. 3, a flow chart depicting a method in accordance with an embodiment of a present teachings. In block 310, a communication connection is first established between the communication unit in vehicle sub-system (130) and its counterpart (230) in mobile phone sub-system (200). In one embodiment of the present invention, the communication is performed using Bluetooth technology. One of the devices (e.g. 230) plays the role of “peripheral” and the other (e.g. 130) plays the role of “central”. The connection is established by standard “advertising” and “discovering” mechanism, as specified in the Bluetooth protocol, when the mobile phone carrier is in a relatively close range (less than 100 meter) to the vehicle.

In block 320, an authorization code is transmitted from the mobile phone through the established communication connection to the vehicle sub-system. The vehicle sub-system checks the authorization code to ensure that the mobile phone contains the authorization and authentication information. If the authorization verification fails (No in block 330), the control returns to block 310.

If a successful authorization is obtained (Yes in block 330), the distances between the acoustic unit 250 in the mobile phone and various acoustic I/O units 150 in the vehicle are estimated in block 340. In this step, acoustic signals are transmitted between the acoustic I/O units 150 in the vehicle and acoustic I/O unit 250 in the mobile phone. In one embodiment of the present invention, the signals are transmitted from the acoustic I/O units 150 in the vehicle, and received by acoustic I/O unit 250 in the mobile phone. The signals from different I/O units in vehicle may transmit at slight different times, so that they do not overlap in time, or they may transmit simultaneously with different frequencies, so that the signals from different sources can be separated from each other at the receiving end. From the time the acoustic signals travel between the devices, the distance between them can be calculated. In another embodiment of the present invention, the acoustic signals are sent by the mobile phone sub-system 200, and are received by various acoustic I/O units 150 in the vehicle sub-system 100. The block 340 will be further explained in details later.

The distances between the mobile phone and the acoustic I/O units 150 are checked in block 350. If the mobile phone is still far away (No in block 350), no action is taken. If the distance is smaller than a threshold (Yes in block 350), further actions could be taken. The distance threshold for different actions may be different. For example, for unlocking the left door, a distance of 0.5 meter from the left door is needed, while for unlocking the trunk, a distance of 0.7 meter from the truck is used as the threshold. To start the engine, a combination of more than one distance measures might be required. For example, it may require the sum of the distances of the mobile phone to the left door and the one to the right door are less than 1.8 meters. This insures the mobile phone is residing in the vehicle.

In block 360, a set of user actions are checked. This is mandatory for starting engine and unlocking the trunk, but could be optional for unlocking the doors. In one embodiment of present invention, users are required to push a start-engine button and press the brake at the same time to ignite the engine. They need to grip the door handle to unlock the doors, and push the unlocking-truck button to unlock the trunk. The sensor information associated with pushing start engine button, pressing break, griping the door handle and pushing the unlocking-truck button are reported from the sensor set unit 160 to the control unit 110.

In one embodiment of present invention, if both the distance conditions (350) and user action conditions (360) are met, the corresponding action is taken in block 370. For example, if the sum of the distances to the left door and the one to the right door is less than 1.8 meters, and the user is pushing the “start engine” button and pressing the break, the engine is ignited. If the distance to the left door is smaller than 0.5 meters, and the user has gripped the left door handle, the left door is unlocked. In another embodiment of present invention, the user action condition may not be required for unlocking the door. For example, the left door is unlocked when the distance between the mobile phone and the left door is smaller than 0.5 meters, without checking the door handle gripping.

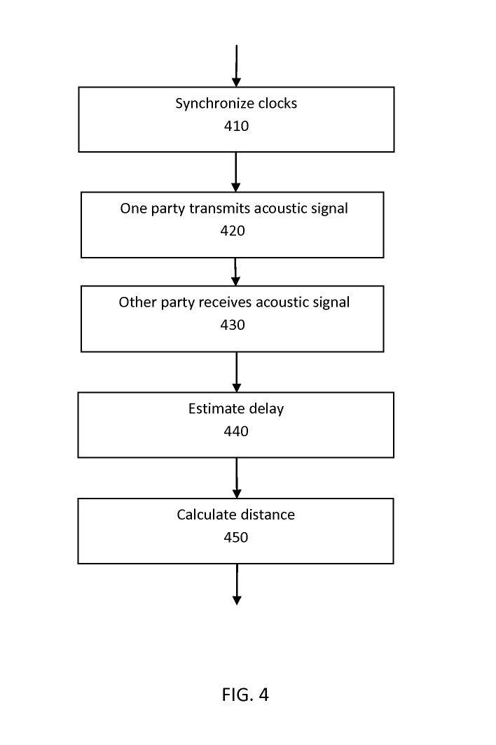

Referring now to FIG. 4, a flow chart depicting a method for estimating distances in accordance with an embodiment of a present teachings. In block 410, the clock units (140) and (240) of the two sub-systems are synchronized. This can be achieved by exchanging the clock information between the two sub-systems through the communication connection established in block 310. In one embodiment of the present invention, the clock unit (240) of the mobile phone sub-system is set to be the same as the clock (140) of the vehicle sub-system. In another embodiment of the present invention, the clock unit (140) of the vehicle sub-system is set to be the same as the clock (240) of the mobile phone sub-system. In yet another embodiment of the present invention, both clock units (140) and (240) are not re-set, but the time difference between the two clocks is recorded.

In block 420, one of the sub-systems sends out acoustic signals. And the signals are received by the other sub-system in block 430. The acoustic signals are preferably in the high frequency range (for example close to 20K Hz or even higher) that is not or barely perceptible by human ears. In one embodiment of the present invention, the acoustic I/O units 150 in the vehicle sub-system transmit and the acoustic I/O unit 250 in the mobile phone sub-system receives. For different acoustic I/O units in the vehicle (for example, the one mounted on the left door, the one mounted on the right door, and the one mounted near the trunk), they may transmit at different time without time overlapping, or they may transmit simultaneously with different frequencies, so that the signals from different sources can be separated from each other at the receiving end. In another embodiment of the present invention, the acoustic I/O unit 250 in the mobile phone sub-system transmits and the acoustic I/O units 150 in the vehicle sub-system receive. The signals to be transmitted are known to the receivers. The signals used can be different for different acoustic I/O units. For example, the signals sent from the left door may be different from the ones sent from the trunk.

The time delay is estimated in block 440. This can be achieved by comparing the time the signal is sent and the time the signal is received. In one embodiment of the present invention, the vehicle sub-system sends the signals and the mobile phone sub-system receives. The vehicle records the time the signal is sent, and the mobile phone records the time the signal is received. The receiving time is then communicated to the vehicle sub-system through the communication connection established in block 310. The time delay is calculated between the sending and receiving times, (taking into account of the possible difference between the two clocks, if they are not set to the same time during the synchronization 410). In another embodiment of the present invention, the mobile phone sub-system sends the signals and the vehicle sub-system receives. The mobile phone records the time the signal is sent, and the vehicle records the time the signal is received. The sending time is communicated by the mobile phone to the vehicle sub-system through the communication connection established in block 310. The time delay is calculated between the sending and receiving times, (taking into account of the possible difference between the two clocks, if they are not set to the same time during the synchronization 410).

The sending/receiving times may refer to the times of sending/receiving of the start of the signal sequence, or the end of the sequence. They may also refer to a particular “signature” or feature within the sequence. For example, the signal sequence may contain a sharp change in amplitude, frequency, or phase. The sender records the time when such a change occurs, and the receiver detects such a change and also records the time. The delay is estimated by comparing these two recorded times, in consideration of the possible differences between the two clocks.

Once the time delay is estimated, the actual distance between the pair of the acoustic I/O units can be calculated (block 450). This is simply D=ts, where D is the distance, t is the delay and s is the speed of sound in air (about 343 meters per second).

One variation of distance estimation is echoing. The first party (say the vehicle sub-system) transmits the signals and records the time of sending. The second party (say the mobile phone sub-system) sends back the signals once it receives the entire sequence. The first party receives the echo signals and record the receiving time. By comparing the sending and receiving times, the first party is able to estimate the delay and calculate the distance between the two parties as D=0.5(t₁−t₀)s, where t₁ is the time difference between receiving and sending the signals, t₀ is the length of the signal sequence in time.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A wireless vehicle entry and ignition control system comprising:
a vehicle;
a wireless communication unit residing in said vehicle;
a plurality of acoustic input/output units residing in said vehicle;
a plurality of sensors residing in said vehicle;
a plurality of switches residing in said vehicle;
a remote access device;
a wireless communication unit residing in said remote access device;
an acoustic input/output unit residing in said remote access device;
said wireless communication unit residing in said vehicle communicating with said wireless communication unit residing in said remote access device to verify an authorization;
once said authorization verified, a first party of said acoustic input/output units residing in said vehicle and said acoustic input/output unit residing in said remote access device transmitting an acoustic signal and said signal received by a second party of said acoustic input/output units residing in said vehicle and said acoustic input/output unit residing in said remote access device;
determining distances between said acoustic input/output units residing in said vehicle and said acoustic input/output unit residing in said remote access device by measuring the time delay between transmitting and receiving said acoustic signal;
turning on/off said switches when said distances meet a predetermined condition.

2. The system of claim 1, further comprising:
said sensors sensing a user action;

3. The system of claim 1, wherein said sensors comprise:
a sensor for detecting handle gripping (optional);
a sensor for detecting an open-trunk button being pushed;
a sensor for detecting a start-engine button being pushed.

4. The system of claim 1, wherein said switches comprises:
a plurality of switches for unlocking/locking doors;
a switch for unlocking trunk;
a switch for engine ignition.

5. The system of claim 2, wherein said user action comprises:
gripping a door handle (optional);
pushing an open-trunk button; or
pushing a start-engine button.

6. A method for operating a wireless vehicle entry and ignition control method comprising:
communicating by a wireless communication unit residing in a vehicle with a wireless communication unit residing in a remote access device to verify an authorization;
once said authorization verified, a first party of a plurality of acoustic input/output units residing in said vehicle and an acoustic input/output unit residing in said remote access device transmitting an acoustic signal and said signal received by a second party of said acoustic input/output units residing in said vehicle and said acoustic input/output unit residing in said remote access device;
determining distances between said acoustic input/output units residing in said vehicle and said acoustic input/output unit residing in said remote access device by measuring the time delay between transmitting and receiving said acoustic signal;
turning on/off a switch in said vehicle when said distances meet a predetermined condition.

7. The method of claim 6, further comprising:
sensing a user action by a plurality of sensors residing in said vehicle;

8. The method of claim 7, wherein said sensors comprise:
a sensor for detecting handle gripping (optional);
a sensor for detecting an open-trunk button being pushed;
a sensor for detecting a start-engine button being pushed.

9. The method of claim 6, wherein said switches comprises:
a plurality of switches for unlocking/locking doors;
a switch for unlocking trunk;
a switch for engine ignition.

10. The method of claim 7, wherein said user action comprises:
gripping a door handle (optional);
pushing an open-trunk button; or
pushing a start-engine button.
